(19) United States
(12) Patent Application Publication
(10) Pub. No.: US 2019/0080363 A1
(43) Pub. Date: Mar. 14, 2019

(54) METHODS AND SYSTEMS FOR INTELLIGENT ADAPTIVE BIDDING IN AN AUTOMATED ONLINE EXCHANGE NETWORK

(71) Applicant: Amadeus S.A.S., Biot (FR)

(72) Inventors: Rodrigo Acuna Agost, Golfe Juan (FR); Alejandro Ricardo Mottini D'Oliveira, Nice (FR); David Renaudie, Valbonne (FR)

(21) Appl. No.: 15/704,647

(22) Filed: Sep. 14, 2017

(51) Int. Cl. G06Q 30/02; G06F 17/11; G06N 5/02; G06N 99/00; G06F 17/18

(52) U.S. Cl. CPC G06Q 30/0275; G06F 17/11; G06F 17/18; G06N 99/005; G06N 5/022

(57) ABSTRACT

Methods and computing apparatus for intelligent adaptive bidding in an automated online exchange network. A message comprising a bid request is received that includes site and user information relating to an available ad slot. A ranked list of offers is generated based at least in part on the site and user information. For each offer in the ranked list, an offer-level estimate of probability of user interaction with the offer is computed. For at least one combination of offers in the ranked list, an ad-level bid price is computed based on at least the computed offer-level estimates of probability of user interaction, corresponding offer-level interaction revenues, and an aggressiveness parameter that controls aggressiveness of bid pricing. Machine learning models for predicting behavior of online users are able to automatically determine estimates of probability of user interaction with online content elements based upon aggregated behavior of prior users in similar contexts.

### TECHNICAL FIELD

The present invention relates to automated bidding systems.

### BACKGROUND

Online (e.g., web-based, mobile, or in-app) advertising differs from advertising in traditional media in its degree of personalized audience targeting. For example, while broadcast media advertising, such as television advertising, aims to reach a target demographic defined by broad characteristics such as age-group, socioeconomic status, and/or general interests, online advertising aims to reach individuals having a particular interest in the product, service, or information that is presented.

Highly personalized audience targeting technology has led to the development of business models that are specific to online advertising. For example, it is now common for websites that provide news, aggregated information, and other content of interest to particular users, to host third-party advertisements as a means for generating revenue. Advertisers whose advertisements appear on these websites may pay the operator on the basis of viewing opportunities or impressions (commonly measured as ‘cost per thousand impressions’, a.k.a. CPM), on the basis of a cost per click (CPC), or according to some other measure of performance. The actual selection of an advertisement to be placed on a web page presented to an individual user may be based, at least in part, on a bidding process whereby an advertiser who is willing to pay a higher CPM, CPC, or other cost measure, is more likely to have its advertisement presented to the user.

According to one common model, the bidding process is facilitated by an ‘ad exchange platform’. An ad exchange is a technology platform that implements a digital marketplace allowing advertisers and publishers of web sites and other online content to buy and sell advertising space, often through real-time auctions.

An ad exchange platform maintains a ‘pool’ of ad slots. Publishers contribute their ad impressions, e.g., available advertising slots embedded within web pages served to users, into the pool. Buyers can then bid for the impressions that they wish to purchase. Bidding decisions are often made in real time based on information such as the previous behavior of the user an ad is being served to, time of day, device type, ad position, and so forth. In practice, these bidding decisions must themselves be made very rapidly, e.g., in at most a few tens of milliseconds, using technology platforms commonly known as demand side platforms (DSPs). Since there is a real cost to the advertiser in purchasing impressions through an ad exchange, the performance of technologies and algorithms deployed in a DSP for assessing the potential ‘value’ of a user in order to make a bid decision may have a significant business impact.

In a typical configuration, each bid request received at a DSP from an ad exchange comprises ad-level information in relation to an available ad slot. The ad-level information may include slot size (e.g., dimensions in pixels), the URL of the website, position of the slot on the web page, an identifying ad slot key, and so forth. The bid request may also include context information, such as browser information, the type of user device, and so forth. Additionally, user-level information may be available, such as a cookie id from a previous visit, IP address, and so forth. A typical DSP may receive several hundred million such requests per day. Accordingly, the DSP much be capable of handling thousands of bid requests per second.

The expected response from the DSP is a bid price, in a currency supported by the ad exchange, for each proposed ad slot. If the DSP is too slow to respond, or offers a low bid price, it may be beaten in the bidding by a competing DSP, and will therefore lose the opportunity to place an ad in the offered slot. On the other hand, if the DSP responds quickly with a high bid price, it may win the opportunity to place selected ad content within the offered slot. However, for the DSP to function successfully overall, the bid price must be reasonable, and the selected ad content must be well-targeted to the end user, in order to ensure a sufficiently high click through rate (CTR). If, for example, bids placed by the DSP are too high and/or ad content is not well-targeted to the end users, the total revenue generated by the DSP, given by the sum of the CPC paid by advertisers for all clicked ads, will be less than the total operating cost, which includes the cost to the DSP operator of all successful bids.

There is therefore a technical requirement that methods employed by the DSP be both accurate and very fast when computing a bid price.

A further complication arises because each ad slot can potentially be populated by a number of distinct offers. Typically, an ad slot comprises a ‘banner’, consisting of a horizontally- or vertically-oriented rectangular region (depending upon layout within a web page), and distinct offers may be arranged in a grid layout within the slot. While the offers may all be related to a common user interest, each may have quite different characteristics. For example, in the context of travel-related advertising, different offers within an ad slot may relate to accommodation, dining, car rental, travel upgrades, and so forth. The CPC revenue generated from a user interaction (i.e., click) event may be different for each offer within the ad slot. However, a DSP is required to respond to a bid request with a corresponding bid price at the ad slot level.

It is therefore desirable that the methods employed by the DSP be capable of computing an ad-level bid price based upon offer-level probabilities of user interaction.

Yet another issue for a DSP is that different campaigns conducted by ad purchasers may have different objectives, and thus different risk and cost profiles. For example, in a campaign targeting growth in market share, an advertiser may be prepared to pay a higher CPC, allowing the DSP to risk making higher bids for a given estimated CTR. Conversely, in a low-value campaign, the DSP may be constrained to bid in a very conservative manner, even if less traffic would then be generated.

It is therefore desirable that the methods employed by the DSP be dynamically-configurable to vary a degree of ‘aggressiveness’ when computing ad-level bid price.

Accordingly, embodiments of the present invention are directed to addressing the above-mentioned desirable characteristics, i.e., computing offer-level probabilities of interaction and ad-level bid prices and implementing variable aggression, while also meeting technical requirements of speed and accuracy.

### SUMMARY

Embodiments of the invention may provide an intelligent, adaptive method and system for generating bid pricing based upon predictions of user interaction behavior and a variable aggressiveness setting. Embodiments of the invention employ machine learning models for predicting behavior of online users, and are able to automatically determine likelihood of user interaction with online content elements based upon aggregated behavior of prior users in similar contexts. Embodiments of the invention may be applied in online advertising systems, for example to determine a bid price for placement of an advertisement to be presented to a user, e.g., via a web page within a mobile app.

In embodiments of the invention, a method includes receiving, from an ad exchange server via a data communications network, a message comprising a bid request which includes site information and user information relating to an available ad slot; generating a ranked list of offers selected from an active offers database, wherein ranking of the offers is based at least in part on the site information and the user information; for each offer in the ranked list, computing an offer-level estimate of probability of user interaction with the offer; for at least one combination of offers included in the ranked list, computing an ad-level bid price, wherein the ad-level bid price is based on at least the computed offer-level estimates of probability of user interaction, corresponding offer-level interaction revenues, and an aggressiveness parameter that controls aggressiveness of bid pricing; and transmitting, to the ad exchange server via the data communications network, a message comprising a bid response including a bid-priced ad which comprises the combination of offers and the ad-level bid price.

Advantageously, embodiments of the invention are thereby able to compute ad-level bid pricing based upon offer-level information and estimates of probability of user interaction with individual offers. Experiments employing an embodiment of the invention have shown significant enhancements in click through rate (CTR) over conventional methods of computing bid pricing within ad exchange networks. Further increases in CTR have been observed when increasing aggressiveness of bid pricing via adjustment of the aggressiveness factor.

According to embodiments of the invention, the aggressiveness factor is variable between two limits. A first limit may be a ‘conservative’ bidding limit, while a second limit may be an ‘aggressive’ bidding limit. The ‘conservative’ bidding limit may be based upon a weighted average of estimated probability of user interaction, while the ‘aggressive’ bidding limit may be based upon an expectation that a user interacts with an offer having a highest combination of estimated probability of user interaction and offer-level interaction revenue. With an appropriate parameter definition, the aggressiveness parameter limits may both be finite values, and in an exemplary embodiment the aggressiveness parameter is continuously-variable, e.g., between zero (‘conservative’ limit) and one (‘aggressive’ limit).

Advantageously, embodiments of the invention employ a machine learning model for computation of the offer-level estimates of probability of user interaction with each offer. The machine learning model may be trained based upon matching of aggregated content placement events with aggregated user interaction events, and may be configured for efficient representation to enable rapid computation of the offer-level estimates of probability of user interaction with each offer, e.g., in under a few tens of milliseconds. In embodiments of the invention, the machine learning model is continuously or periodically trained online, and the representation used for computation of the offer-level estimates of probability is periodically-updated to ensure that the estimates are based upon sufficiently current information.

In embodiments of the invention, a computing apparatus is provided which implements a demand side platform. The computing apparatus includes a processor, at least one memory device accessible by the processor, and a data communications interface operably associated with the processor. The memory device contains a body of program instructions including instructions which, when executed by the processor, cause the computing apparatus to: receive, from an ad exchange server via the data communications interface, a message comprising a bid request which includes site information and user information relating to an available ad slot; generate a ranked list of offers selected from an active offers database, wherein ranking of the offers is based at least in part on the site information and the user information; for each offer in the ranked list, compute an offer-level estimate of probability of user interaction with the offer; for at least one combination of offers included in the ranked list, compute an ad-level bid price, wherein the ad-level bid price is based on at least the computed offer-level estimates of probability of user interaction, corresponding offer-level interaction revenues, and an aggressiveness parameter that controls aggressiveness of bid pricing; and transmit, to the ad exchange server via the data communications interface, a message comprising a bid response including a bid-priced ad which comprises the combination of offers and the ad-level bid price.

The aggressiveness parameter may comprise a continuous numerical value a for which the program instructions cause the computing apparatus to implement the action of computing the ad-level bid price BP based upon a formula:

$$BP ( α ) = ( \frac{1 - α}{n} + α ) \cdot {‖ ERPO ‖}_{1 / ( 1 - α )}$$

wherein:

ERPO=R∘P

R=[R₁, R₂, . . . , Rₙ] is a vector of offer-level interaction revenues generated from user interaction with each offer Oᵢ (i=1, 2, . . . , n) in the ranked list of offers

P=[P₁, P₂, . . . , Pₙ] is a vector of the computed offer-level estimates of probability of user interaction

n is a number of offers to be included in the available ad slot, and

‘∘’ denotes an element-wise product of vectors.

Advantageously, the aggressiveness parameter a may be varied over a continuous range, enabling substantially greater control over behavior of the system between discrete aggressiveness setups such as have been employed previously. The DSP is thereby able to select bidding behavior using a smooth aggressiveness control method, rather than being constrained to specific categorical behaviors.

In embodiments of the invention, the offer-level interaction revenues comprise cost-per-click (CPC) values agreed between an operator of the demand side platform and respective advertisers of the offers selected from the active offers database.

The above summary may present a simplified overview of some embodiments of the invention in order to provide a basic understanding of certain aspects of the embodiments of the invention discussed herein. The summary is not intended to provide an extensive overview of the embodiments of the invention, nor is it intended to identify any key or critical elements, or delineate the scope of the embodiments of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification and in which like reference numerals refer to like features, illustrate various embodiments of the invention and, together with a general description given above and the detailed description given below, serve to explain the embodiments of the invention.

FIG. 1 is a schematic diagram illustrating an exemplary networked system in accordance with embodiments of the invention.

FIG. 2 shows a timeline of communications between a user device, a web server, an ad exchange server, and a DSP in accordance with embodiments of the invention.

FIG. 3 is a block diagram illustrating schematically a number of code modules comprising an online user interaction prediction and ad-level bidding engine in accordance with embodiments of the invention.

FIG. 4 shows a flowchart of a method of online updating of a machine learning model for online user interaction prediction.

FIG. 5 shows a flowchart of a method of feature engineering and model hyperparameter optimization of the machine learning model.

FIG. 6 is a block diagram illustrating schematically a number of code components of the real-time bidding module shown in FIG. 3.

FIG. 7 is a flowchart of a method of estimation of expected CTR using the machine learning model for online user interaction prediction.

FIG. 8 is a flowchart of a method of generating a bid response, including a bid price, according to an embodiment of the invention.

FIG. 9 is a flowchart of a method of generating a bid-priced ad comprising one or more offers according to an embodiment of the invention.

FIG. 10 is a flowchart of a method of operating a real-time bidding module according to embodiments of the invention.

FIG. 11 shows a chart illustrating performance of a real-time bidding module in accordance with embodiments of the invention.

### DETAILED DESCRIPTION

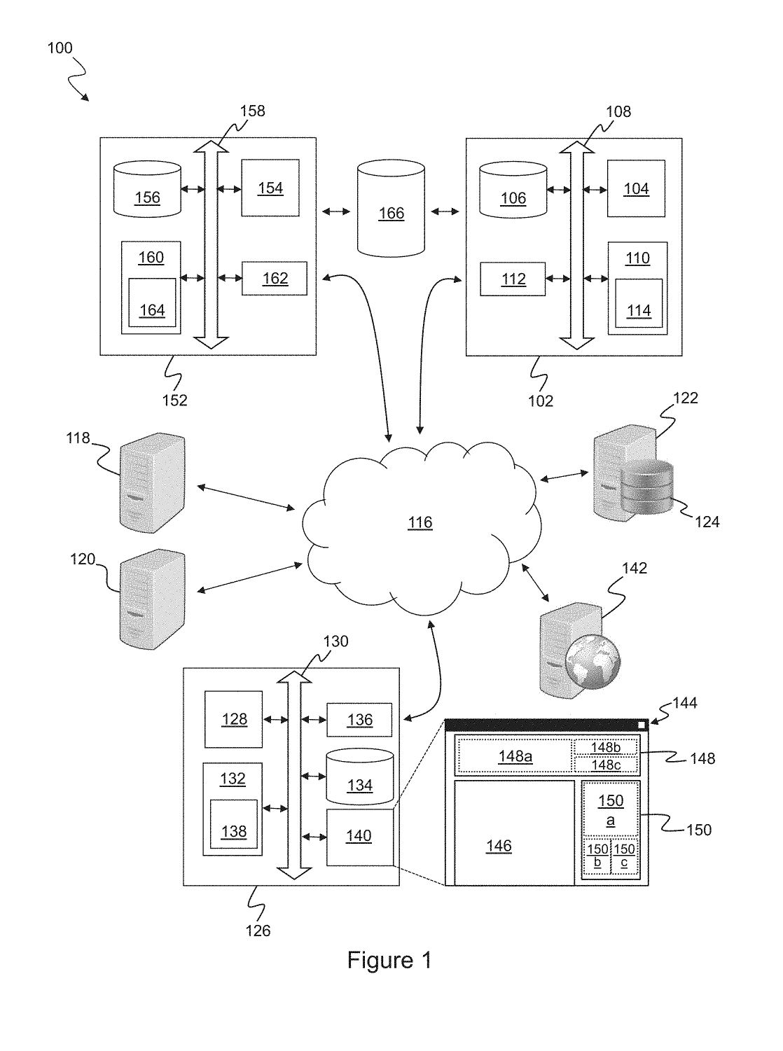

FIG. 1 is a block diagram illustrating an exemplary networked system 100 including a demand side platform (DSP) server 102, which is configured to implement a method of bidding for placement of advertising content in accordance with an embodiment of the invention. The DSP server 102 may comprise a computer system of a given architecture. In particular, the DSP server 102, as illustrated, comprises a processor 104 or more than one processors 104. The processor 104 is operably associated with at least one non-volatile memory/storage device 106, e.g., via one or more data/address busses 108 as shown. The non-volatile storage 106 may be a hard disk drive, and/or may include a solid-state non-volatile memory, such as ROM, flash memory, solid-state drive (SSD), or the like. The processor 104 is also interfaced to volatile storage 110, such as RAM, which contains program instructions and transient data relating to the operation of the DSP server 102.

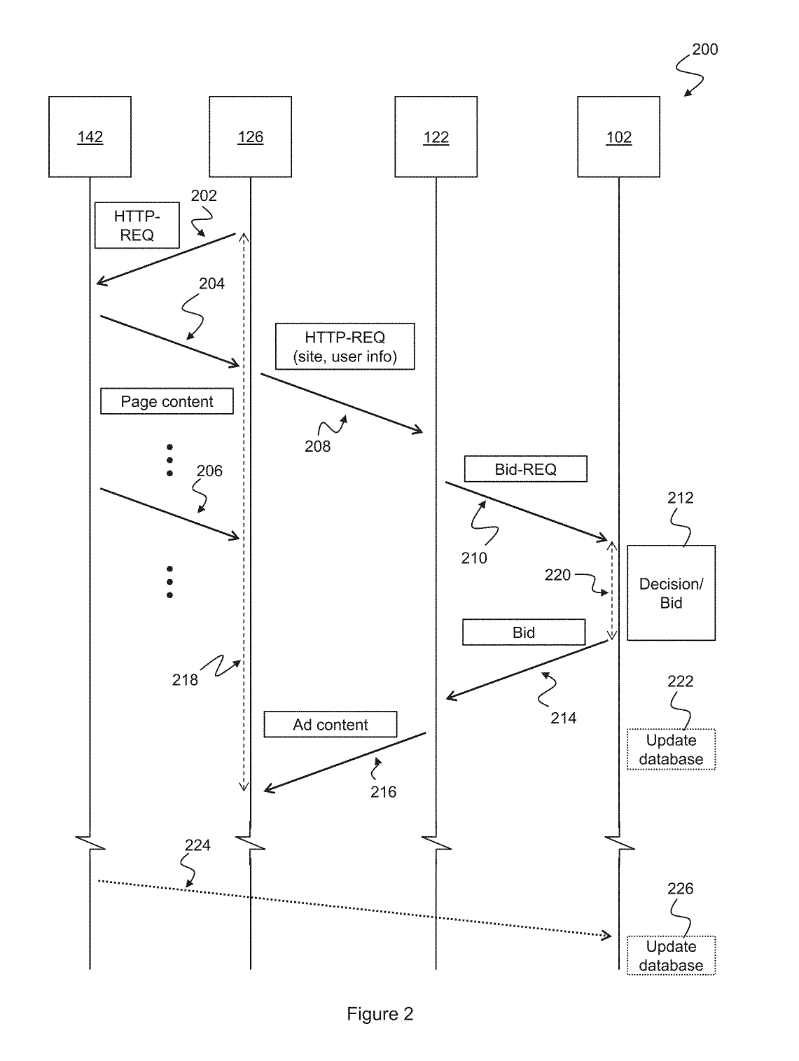

The storage device 106 maintains program and data content relevant to the normal operation of the DSP server 102. For example, the storage device 106 may contain operating system programs and data, as well as other executable application software necessary for the intended functions of the authentication server 102. The storage device 106 also contains program instructions which, when executed by the processor 104, cause the DSP server 102 to perform operations relating to an embodiment of the present invention, such as are described in greater detail below, and with reference to FIGS. 2 and 6-10 in particular. In operation, instructions and data held on the storage device 106 are transferred to volatile storage 110 for execution on demand.

The processor 104 is also operably associated with a communications interface 112. The communications interface 112 facilitates access to a wide-area data communications network, such as the Internet 116.

In use, the volatile storage 110 contains a corresponding body of program instructions 114 transferred from the storage device 106 and configured to perform processing and other operations embodying features of the embodiments of the present invention.

With regard to the preceding overview of the DSP server 102, and other processing systems and devices described in this specification, terms such as ‘processor’, ‘computer’, and so forth, unless otherwise required by the context, should be understood as referring to a range of possible implementations of devices, apparatus and systems comprising a combination of hardware and software. This includes single-processor and multi-processor devices and apparatus, including portable devices, desktop computers, and various types of server systems, including cooperating hardware and software platforms that may be co-located or distributed. Physical processors may include general purpose CPUs, digital signal processors, graphics processing units (GPUs), and/or other hardware devices suitable for efficient execution of required programs and algorithms. Computing systems may include personal computer architectures, or other general-purpose hardware platforms. Software may include open-source and/or commercially-available operating system software in combination with various application and service programs. Alternatively, computing or processing platforms may comprise custom hardware and/or software architectures. For enhanced scalability, computing and processing systems may comprise cloud computing platforms, enabling physical hardware resources to be allocated dynamically in response to service demands. While all of these variations fall within the scope of the embodiments of the present invention, for ease of explanation and understanding the exemplary embodiments described herein are based upon single-processor general-purpose computing platforms, commonly available operating system platforms, and/or widely available consumer products, such as desktop PCs, notebook or laptop PCs, smartphones, tablet computers, and so forth.

In particular, the term ‘processing unit’ is used in this specification (including the claims) to refer to any suitable combination of hardware and software configured to perform a particular defined task, such as accessing and processing offline or online data, executing training actions of a machine learning model, or executing prediction actions of a machine learning model. Such a processing unit may comprise an executable code module executing at a single location on a single processing device, or may comprise cooperating executable code modules executing in multiple locations and/or on multiple processing devices. For example, in some embodiments of the invention classification and bid pricing/decision processing may be performed entirely by code executing on DSP server 102, while in other embodiments corresponding processing may be performed in a distributed manner over a plurality of DSP servers.

Software components, e.g., program instructions 114, embodying features of the invention may be developed using any suitable programming language, development environment, or combinations of languages and development environments, as will be familiar to persons skilled in the art of software engineering. For example, suitable software may be developed using the C programming language, the Java programming language, the C++ programming language, the Go programming language, and/or a range of languages suitable for implementation of network or web-based services, such as JavaScript, HTML, PHP, ASP, JSP, Ruby, Python, Perl, and so forth.

Returning to FIG. 1, the system 100 further comprises additional DSP servers, e.g., 118, 120 that, in use, compete with DSP server 102 to bid for placement of advertising content within online ad slots offered via an ad exchange server 122. The ad exchange server 122 implements a digital marketplace allowing advertisers and publishers of web sites and other online content to buy and sell advertising space in the form of a real-time, online auction in which each DSP server 102, 118, 120 is an automated, high-speed, bidder. The ad exchange server 122 comprises a database 124 in which it maintains details of online content providers (web servers) and advertisers (DSPs) for the purpose of operating a digital advertising marketplace.

The system 100 further includes user terminal devices, exemplified by terminal device 126. The terminal devices 126 may be, for example, desktop or portable PCs, smartphones, tablets, or other personal computing devices, and each comprise a processor 128 interfaced, e.g., via address/data bus 130, with volatile storage 132, non-volatile storage 134, and at least one data communications interface 136. The processor 128 is also interfaced to one or more user input/output (I/O) interfaces 140. The volatile storage 132 contains program instructions and transient data relating to the operation of the terminal device 126.

The terminal device storage 132, 134 may contain program and data content relevant to the normal operation of the device 126. This may include operating system programs and data (e.g., associated with a Windows, Android, iOS, MacOS, Linux, or other operating system), as well as other executable application software. The volatile storage 132 also includes program instructions 138 which, when executed by the processor 128 enable the terminal device to provide a user with access to online content. For example, the program instructions 138 may implement a web browser having a graphical user interface (GUI) presented via the user I/O interface 140.

Accordingly, in the event that a user of the terminal device 126 access a web server 142, a corresponding web page display 144 is generated via the device UI 140. The display 144 include website content 146, and one or more advertising slots, e.g., 148, 150. As is further illustrated, each advertising slot 148, 150 may comprise a plurality of specific ‘offers’ on behalf of an advertiser. These offers are commonly arranged in a grid layout, e.g., as indicated by dashed rectangles 148a, 148b, 148c, 150a, 150b, 150c in FIG. 1. A number of communications actions then take place in order to populate these slots, i.e., to provide online advertisers with ad impressions within the web page display 144. These communications actions will now be described with reference to the timeline 200 illustrated in FIG. 2.

Initially, the user terminal 126, via the executing web browser application 138 and responsive to user input, transmits 202 an HTTP request to the web server 142 which includes a URL of desired web content. The web server 142 responds by transmitting 204 content, e.g., a web page in HTML format, to the user device 126. The complete population and rendering of web page display 144 may require multiple requests and responses, and may involve further transactions with the web server 142 and/or with other online servers, such as content distribution network (CDN) servers and other web servers providing embedded content. For simplicity, all such additional transactions are represented by a single exemplary communication 206 in FIG. 2.

In order to obtain advertising content to fill the slots 148, 150, the web page transmitted by the web server 142 to the user device 126 typically includes a hypertext reference (href) directing the browser 138 to retrieve content from the ad exchange server 122 in accordance with an application programming interface (API) defined and provided by the relevant operator of the exchange server 122. Accordingly, the user device 126 transmits 208 an HTTP request to the ad exchange server 122. The request includes web site information and user information relating to the user of the terminal device 126. Available user information may include information that the web server 142 has gathered, and may include client-side information, such as device and browser identity and technical details, identifying information and contents of browser cookies, and the like.

The ad exchange server 122 receives the request, identifies relevant DSP servers 102, 118, 120 in its database 124, and transmits 210 bid request messages to each selected DSP server. One such bid request message, including site and user information, is received at DSP server 102 embodying the present invention, which executes a process 212 in accordance with its specific programming 114 in order to predict a likelihood of user interaction with a selected ad including one or more offers, placed within one or more of the available slots 148, 150, and arrive at a bid decision. In the event that a decision is made to bid for the offered impression, and a bid value determined, the DSP server 102 then transmits 214 the bid to the ad exchange server 122.

The ad exchange server 122 receives all bids transmitted from DSP servers, including server 102, and selects a winning bid. It then retrieves ad content corresponding with the winning bid from its database 124, and transmits 216 the ad content to the user device 126 for rendering within the corresponding ad slot, e.g., 148 or 150.

From a user's perspective, the speed to fully load a web page should not be excessive. For example, a load time that exceeds a few seconds, e.g., 3 seconds 218, may be considered excessive. There are, as has been described above, many actions necessary to fully serve all content of a complex web page, which may involve multiple servers across the global internet. Accordingly, the duration of the bidding process facilitated by the ad exchange server 122 should be limited. For example, the DSP server 102 should make a bid decision in no more than a few tens of milliseconds, for example in under 30 milliseconds 220. This decision may be made with limited user information, and in view of the fact that a bad decision may have significant consequences for the advertiser. For example, if the DSP server wrongly determines that the user is a desirable target for a particular ad (i.e., computes a ‘false positive’), it may place a relatively high winning bid and incur a real cost with little or no prospect of any return. Conversely, if the DSP server wrongly determines that the user is not a desirable target for the ad (i.e., computes a ‘false negative’), it may place no bid, or a low losing bid, and cause the advertiser to miss an opportunity to obtain an impression with a real prospect of a return.

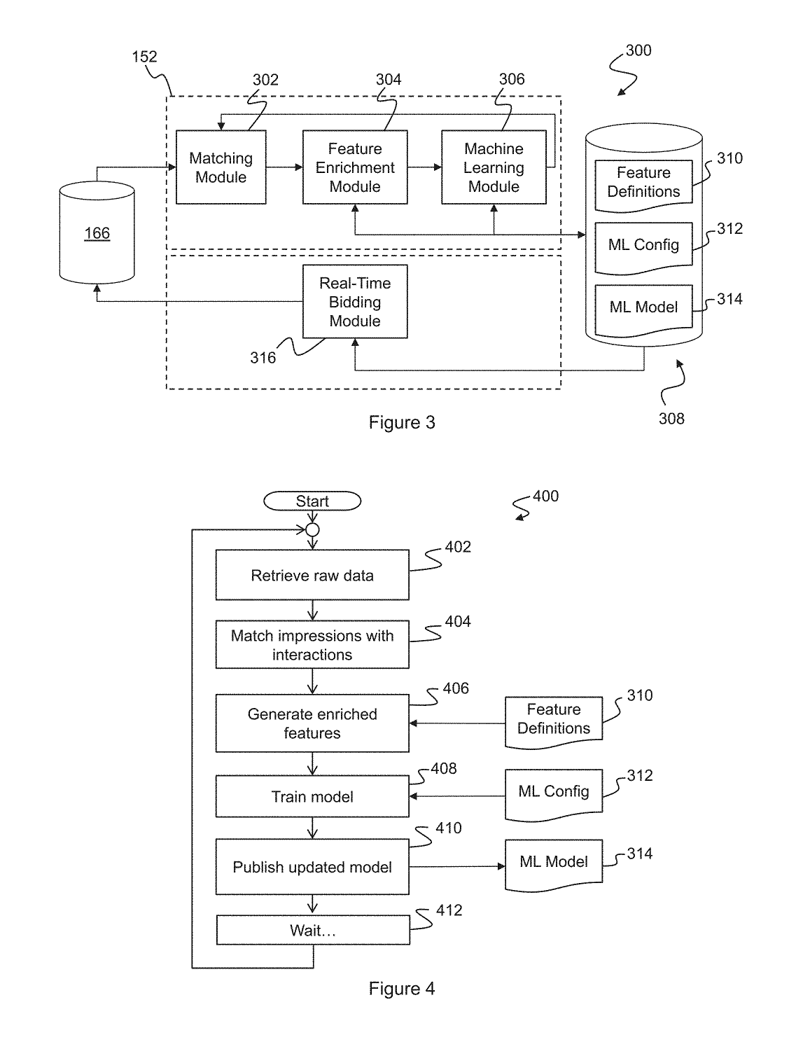

In order to achieve quality decision-making at high speed in the context of travel booking services, embodiments of the present invention may employ a machine learning approach. To further facilitate understanding of this approach, reference is now made back to FIG. 1, in which the system 100 further includes a machine learning server (‘ML server’) 152, which is configured to process raw data relating to placement of content (i.e., ads/offers) along with user interactions (i.e., user clicks on ads/offers), to generate training data sets for a machine learning model, and to train the machine learning model for deployment to the DSP server 102. The processing, training and deployment actions are described in greater detail below, with reference to FIGS. 3 and 4, and may be carried out continuously, periodically and/or on-demand in order to maintain currency of the machine learning model.

As with the DSP server 102, the ML server 152 may comprise a computer system having a given architecture, e.g., comprising a processor 154 that is operably associated with a non-volatile memory/storage device 156, via one or more data/address busses 158 as shown. The processor 154 is also interfaced to volatile storage 160 which contains program instructions and transient data relating to the operation of the ML server 152. The storage device 156 contains operating system programs and data, as well as other executable application software necessary for the intended functions of the ML server 152, and including program instructions which, when executed by the processor 154, cause the ML server 152 to perform operations described in greater detail below, with reference to FIGS. 3 and 4 in particular. In operation, instructions and data held on the storage device 156 are transferred to volatile memory 160 for execution on demand. Additionally, the processor 154 is operably associated with a communications interface 162, providing access to the Internet 116.

In use, the volatile storage 160 contains a corresponding body of program instructions 164 transferred from the storage device 156 and configured to perform processing, training and deployment actions for a machine learning model. The program instructions 164 comprise a further specific technical contribution to the art in accordance with this embodiment.

The system 100 further includes at least one database 166, which is configured to store raw historical data relating to placement of content (i.e., ads/offers) along with user interactions (i.e., user clicks on ads/offers). The volume of such data may be very large over time periods of interest, such as one month or more. For example, in a particular live deployment, it was found that a log of data for a single day comprises on the order of 20 million lines (i.e., placement and interaction events) having a total storage size on the order of 10 Gb. Accordingly, the database 166 is preferably implemented using technologies that are optimized for efficient storage, retrieval and update of very large volumes of data (sometimes referred to as ‘big data’) across multiple database servers and storage devices. While a number of suitable commercial and open source technologies exist for implementation of the database 166, an exemplary experimental configuration has been implemented using Apache Hadoop framework, with data stored in Parquet format on HDFS (Hadoop Distributed File System), and using Impala to provide a high-speed, SQL-like query engine. This implementation has been tested and found to provide more than adequate performance for practical online deployment.

The database 166 is accessible to both the DSP server 102 and the ML server 152. In FIG. 1, logical access is illustrated by corresponding arrows. In a practical embodiment, physical access between the database 166 and the DSP and ML servers 102, 152 may be via the Internet 116, and/or via other dedicated communications links or networks, such as a local storage area network (SAN). The DSP server 102 is configured to update the database 166, in real time, with raw data relating to placement and interaction events. The ML server 152 is configured to retrieve the raw data from the database 166 and to carry out processing, training and deployment actions, based on the retrieved data.

Returning to FIG. 2, further operations relating to update of the database 166 by the DSP server 102 are illustrated. In particular, in the event that the DSP server 102 places a successful bid, and corresponding ad content is transmitted 216 to the user device 126, the DSP server 102 updates 222 the database 166, adding data relating to the placement of the ad (i.e., ad/offer impression). Code associated with the ad is configured such that, in the event that the user subsequently interacts with (i.e., clicks on) the ad, the DSP server 102 receives, either directly or indirectly, a notification 224 of this interaction event. The DSP server 102 then updates 226 the database 166 with details of the interaction event. In this way, the database 166 is continuously updated with raw data relating to all placement and interaction events known to the DSP server 102.

FIG. 3 is a block diagram illustrating schematically a number of code modules that together comprise an online user interaction prediction and real-time bidding engine 300 embodying the invention. Implementation of the user interaction prediction and bidding engine 300 is distributed across the ML server 152 and DSP server 102, as shown by the dashed boxes in FIG. 3. Three code modules make up the ML server component of the engine 300, namely a matching module 302, a feature enrichment module 304 and a machine learning module 306. These three modules are all implemented within the program instructions 164 executing on the ML server 152. The functionality implemented within each of these modules will now be described in greater detail.

The purpose of the matching module 302 is to match placement events (i.e., display of ads, and offers within ads, in ad slots 148, 150 of the display 144 of the user device 126) to subsequent interaction events (i.e., instances of a user clicking on an offer within an ad placed on the display 144 of the user device 126). Matching enables placement events to be tagged as ‘clicked’ or ‘not clicked’, so that they can be used by machine learning module 306 in training of a supervised machine learning model for prediction of user interaction events based upon placement event data. Additionally, matching enables placement event data to be combined with corresponding interaction event data to create a record for clicked ads containing all available information regarding placement and interaction.

Matching presents a challenge because there is no explicit link between a placement event (ad impression) and a subsequent user interaction (ad click). As illustrated in the time line 200 of FIG. 2, a user interaction may occur at any time following placement, e.g., following a substantial delay. Since new placement and/or interaction events may occur at a very high rate (e.g., hundreds or thousands of times per second) in a live system, corresponding placement and interaction events may become widely separated in the database 166. Additionally, the rate of interaction events may be very low, e.g., it is generally reported that the click through rate (CTR) for web-based display advertising is on the order of 0.05%. Furthermore, it is desirable to link placement and interaction events at offer level, rather than only at ad level.

The general approach employed for matching is to identify, in the database 166, placement events and subsequent interaction events within a predetermined time window that have a selected set of matching parameters. The time window should be of sufficient duration to capture a substantial majority of all interactions, and the number and choice of parameters should be sufficient to ensure unique matching in a substantial majority of cases. Perfect matching may be difficult to achieve, because it is impossible to know if or when an interaction will occur. A time window of longer duration will capture interactions that occur after longer delays, but will also increase the risk of erroneous matching where, for example, a user interacts with a subsequently-presented ad having similar parameters. Similarly, the risk of erroneous matching can be reduced by using a larger selected set of parameters to distinguish between presented ads, at the expense of making the matching process more complex.

In an exemplary experimental configuration, an embodiment of the invention has been implemented in the context of a domain-specific DSP server operating on behalf of advertisers, using event data captured from a live system. A heuristic approach was taken to design of the matching module, with a number of experiments being conducted to determine a suitable time window, and a selected set of parameters. An 80 second time window was found to be effective in combination with matching the following event parameters: unique user identifier (tracked via a browser cookie); advertiser identifier; publisher identifier (i.e., the ad exchange/distribution network through which the ad was placed); format of the clicked offer (e.g., width and height of offer graphic, in pixels); ad product type; ad product pool; user segment (a combination of a user product segment, based upon a product such as flight, hotel or restaurant previously viewed by the user, and a user time segment, indicating how long it has been since the last activity of the user); site URL; ad slot visibility; user device; a measure of distance between a destination (location) about which the user was seeking information and a destination that was the subject of a specific offer; and ad slot key (a stable identifier for the combination of publisher, ad slot and page).

In the exemplary configuration, matching is performed using an Impala SQL query to select and join tables of records of placement and interaction events on the values of fields corresponding with the parameters listed above. Specifically, placement records are LEFT JOINed to interaction records, such that the resulting table includes a row for each placement event. Each row comprises a set of values of raw features derived from the matched events, along with an indicator of whether or not an interaction event, i.e., ad/offer click, occurred. The table of matched data is input to the feature enrichment module 304.

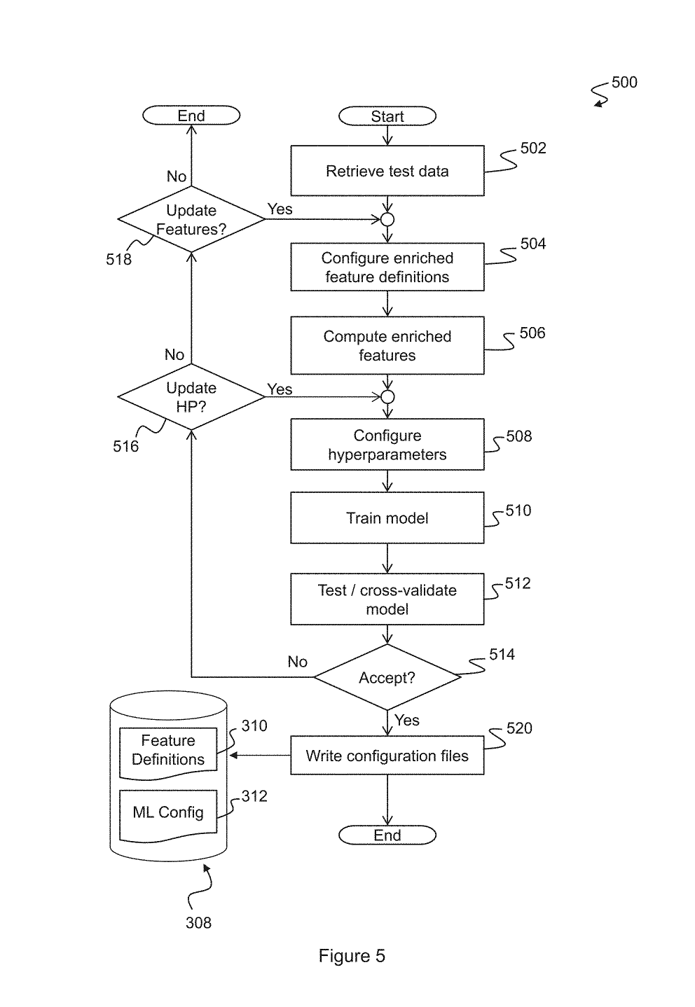

The function of the feature enrichment module 304 is to derive, from the values of raw features in the matched data table generated by the matching module 302, a corresponding set of enriched feature vectors for use by the machine learning module 306. A process for determining a suitable set of enriched features (i.e., feature engineering) is described in detail below with reference to FIG. 5. In FIG. 3, definitions of enriched features for use by the feature enrichment module 304 are shown as being stored in a file 310 within data store 308, however this may be regarded as a schematic convenience. In a practical configuration, feature definitions may be stored in this way, may be compiled into a code module and linked to the feature enrichment module 304, or may be hard-coded into the feature enrichment module. As will be appreciated, each of these implementation options (and others that will be apparent to persons skilled in the art) potentially offers a different trade-off between flexibility, code complexity and execution speed.

In the exemplary configuration, all of the enriched features are of categorical type (i.e., take on one of a number of discrete values), and are one-hot encoded. The resulting feature vectors are therefore generally relatively sparse, and comprise binary elements. Furthermore, each feature vector corresponds with an offer within an ad presented to a user, and is associated with a binary tag indicating whether or not the user interacted with (i.e., clicked on) the offer. The resulting table of feature vectors and tags is input to the machine learning module 306.

The machine learning module 306 comprises program code executing on the ML server 152, and configured in the exemplary experimental configuration to implement a generalized linear model. Specifically, the machine learning module 306 of the exemplary configuration implements a regularized logistic regression algorithm, with ‘follow-the-regularized-leader’ (FTRL)-proximal learning. Advantageously, this machine learning algorithm is known to be effective in the case of highly unbalanced datasets (noting that only around 0.05% of samples in the table of feature vectors are tagged as ‘clicked’). The algorithm has a number of hyperparameters that can be adjusted in order to optimize its learning accuracy on the training data for a specific problem. A process for determining a suitable set of values for the hyperparameters is described in detail below with reference to FIG. 5. In FIG. 3, fixed values of the hyperparameters for use by the machine learning module 306 are shown as being stored in a file 312 within data store 308. As will be appreciated, however, alternative implementations are possible, such as hard-coding the parameters into the machine learning module 306.

Execution of the machine learning module 306 on a particular dataset results in the generation of a model that can be executed by the DSP server 102, as will be described in greater detail below with reference to FIG. 7. In particular, a logistic regression model is wholly characterized by a set of coefficients associated with elements of the input feature vector. In the exemplary configuration, a particularly efficient representation of the model is employed, to enable the DSP server 102 to compute a prediction of the likelihood of a user interaction very rapidly, i.e., well within the 30 millisecond target window 220 for generating a bid decision. Specifically, the coefficients are stored as a dictionary in which each entry is defined by a key and a value. The key is a hashed representation of a concatenation of the feature name (i.e., column label in the feature table) and a corresponding feature value (i.e., categorical values prior to one-hot coding). The associated value in the dictionary is simply the corresponding model coefficient. This type of data structure provides extremely fast lookup, particularly for sparse feature sets. In particular, by using hashed values a limit on the number of hashed features may be imposed (a scheme sometimes referred to as the ‘hashing trick’). This scheme can be used to greatly speed lookup and computation, at the expense of possible collisions in dictionary key values. Advantageously, however, the statistical effect of these collisions can be neglected from the perspective of overall performance of the algorithm.

For deployment to the DSP server 102, the model data structure is serialized in a binary format (in the exemplary configuration the Python ‘pickle’ format is used), and stored in a model file 314 in data store 308.

In use, the ML server 152 executes the modules 302, 304, 306 repeatedly, e.g., continuously, periodically, or on-demand. This is illustrated by the flowchart 400 shown in FIG. 4. Raw data is retrieved from the database 166 at block 402. A predetermined period of recent data may be used, which is considered to be representative of the behavior of current online users of the system 100. For example, raw data from the most recent one-month period may be employed. At block 404, the matching module 302 performs matching of placement and interaction events, as has been described. In practice, retrieval 402 and matching 404 blocks may be combined as a single query, e.g., an Impala SQL query.

At block 406, the ML server 152 executes the feature enrichment module, which uses the enriched feature definitions file 310 to compute enriched feature vectors corresponding with the matched data. These are transferred to the machine learning module 306 which trains (block 408) the model using the tagged feature vectors and the predetermined hyperparameters defined in the configuration file 312. The resulting model coefficients are hashed, serialized and published 410 to the model file 314.

Optionally, the ML server then waits 412, before recommencing the process at block 402. Exit from the wait condition 412 may be triggered by a number of different events. For example, the ML server may be configured to run the modules 302, 304, 306 periodically, e.g., once per day. Alternatively, or additionally, it may be configured to run the modules 302, 304, 306 on-demand, e.g., upon receipt of a signal from a controller (not shown) within the system 100. In some configurations the ML server may run the modules 302, 304, 306 continuously, thereby updating the model file 314 as frequently as possible based upon the time required for data matching, feature enrichment and model training. In an exemplary experimental configuration, it was found that updates based upon 30-minute batches of data provided a suitable trade-off between quality of the output of the matching module 302 (i.e., the need to reconcile interaction and placement events accurately for a good training dataset), and reactivity to the real-time changes in the ad exchange network (e.g., new campaign launches, entry/exit of competitors, changes in user demand for some contents, and so forth).

Turning now to FIG. 5, there is shown a flowchart 500 of a process of feature engineering and model hyperparameter optimization. In practice, the process 500 is partially automated, and operated under human supervision. The development of suitable features with strong predictive capability, and the selection of appropriate ranges of model hyperparameters involves significant experience, judgment, creativity and ingenuity, and in most cases cannot efficiently be fully-automated.

The process 500 requires a set of test data, which is retrieved at block 502, and which may be obtained in the same manner as described above in relation to the functionality of the matching module 302. In particular, data may be extracted from the database 166 for a selected test period using an Impala SQL query of the same form as that used by the matching module 302.

At block 504, a set of enriched features is defined and configured. This action typically involves application of judgment, creativity and ingenuity of an experienced data scientist. In practice, a number of experiments have been performed, according to the process 500 and supported by further analysis of the test data set, in order to identify an effective set of enriched features. At block 506, values of the defined enriched features are computed from the raw test data set.

At block 508, a set of hyperparameter values is selected and a machine learning model is configured with the selected values. At block 510 the resulting model is trained using the enriched test data. Typically, a portion of the test data is held back in the training block 510, which is then used in a cross-validation block 512 to assess the performance of the trained model on data that was not seen during the training block 510.

Performance of the trained model is then assessed at decision block 514, to determine whether or not it is acceptable, for example by reaching some optimal or sufficient level of performance. The choice of criteria for assessing performance may be relevant to identifying an acceptable model. Various known criteria may be employed, such as Area Under the Receiver Operating Curve (AUROC), log loss, or Gini (which is related to the AUROC). In the exemplary configuration, a combination of Gini (which takes values between −1 and 1, and is desirably as high as possible) and log loss (which is desirably as low as possible) was used to assess performance of different models. This approach was employed not only for different hyperparameters of the selected FTRL-Proximal model, but also for a number of alternative models, including decision trees (distributed random forest, gradient boosted trees), naïve Bayes, and deep learning networks, which were consequently rejected as providing inferior performance on the analyzed datasets.

In the event that performance is deemed unacceptable, or an optimization process is incomplete, at decision 514, a further decision 516 is made as to whether to update the model hyperparameters. The resulting loop of configuring hyperparameters, training and testing the model is typically automated using an algorithm such as grid search, or similar. The role of the supervising data scientist in this case is to determine suitable ranges for the grid of hyperparameters.

In the event that no further variation of hyperparameters is required, an outer loop, implemented via decision 518, allows for the testing of alternative sets of enriched features. If available selections and values of model algorithms, hyperparameters and enriched features have been exhausted without identifying an acceptable model, then the process 500 may be regarded as having failed, and a reconsideration of strategy may be required. For the purposes of the exemplary configuration, however, the process 500 led to a model with acceptable performance. At block 520, therefore, the identified enriched feature definitions and model hyperparameters are written to the data files 310, 312 in the data store 308. A summary of the enriched features developed via the process 500 is presented in Table 1.

TABLE 1
Summary of enriched features

| Feature Name | Feature Description |
|---|---|
| ts_day_of_week | The day of the week (Sun-Sat) of the placement event. |
| ts_hour_of_day | The hour of the day (00-23) of the placement event. |
| ts_is_weekend | Whether the placement event occurred on a weekend. |
| ts_is_bank_holiday | Whether the placement event occurred on a bank holiday in the |
| | country from which the user accessed a site. |
| publisher_id | Identifier of publisher (i.e., operator of ad exchange server). |
| advertiser_id | Identifier of advertiser. |
| offer_key | A unique offer identifier, created by combining advertiser_id (see |
| | above) and other advertiser fields (product type and product pool). |
| ad_dst_top199 | A destination associated with an offer. Limited to the top 199 |
| | destinations, which were found in feature engineering experiments |
| | to capture 92% of all clicks. |
| fmt | Format of an offer (width and height of offer image within ad slot) |
| nb_offers_per_ad | Number of offers included with the ad slot. |
| mq_dst | Proximity/distance of destination of interest to the user and |
| | destination associated with an offer. A categorical value indicating |
| | closeness of match on a set scale. |
| user_pseg | Identifier of a product segment previously viewed by user (e.g., |
| | flight, accommodation, restaurant). |
| user_tseg | Identifier of a time segment of the user's previous activity (e.g., |
| | within last day, 24-48 hours ago, . . . , 8-30 days ago). |
| domain_name_top99 | Domain name of site in which ad slot is displayed. Limited to the |
| | top 99 domains, which were found in feature engineering |
| | experiments to capture 95% of all clicks. |
| slot_visibility | Visibility of ad slot within page on user display. |
| device | User device identifier. |
| fmt_device | An engineered feature comprising a combination of offer format |
| | (fmt) and user device identifier (device). |
| ad_slot_key_top499 | A unique identifier for the combination of publisher, ad slot, and |
| | page. Limited to the top 499 values, which were found in feature |
| | engineering experiments to capture 97% of all clicks. |
| camp_type | Categorical identifier of campaign type associated with an offer |
| | (e.g., text + image, image, display banner with dynamic content, |
| | static display banner). |
| user_country_top3 | The country from which the user accessed a site. Limited to the top |
| | three countries, which were found in feature engineering |
| | experiments to capture over 99% of all traffic. Note, however, that |
| | the number and identity of top countries is specific to a publisher/ad |
| | exchange, which may be region and language specific. |
| offer_pos | A categorical value indicating the placement of an offer within an ad |
| | slot. |
| browser | Identifier of user browser (e.g., Chrome, IE, Safari, etc). |

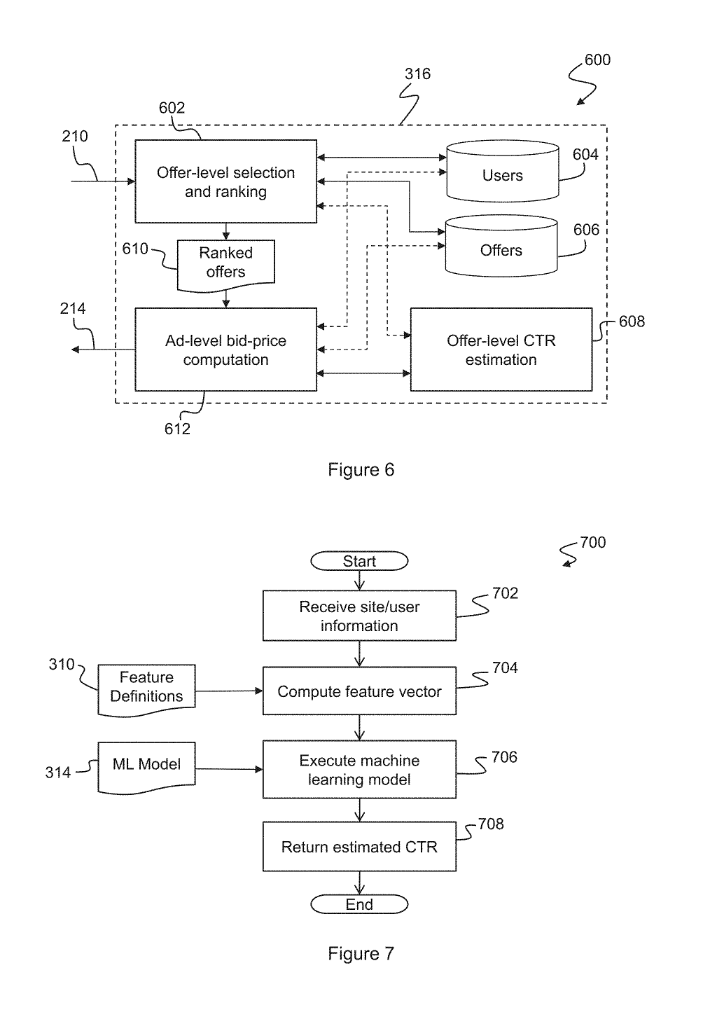

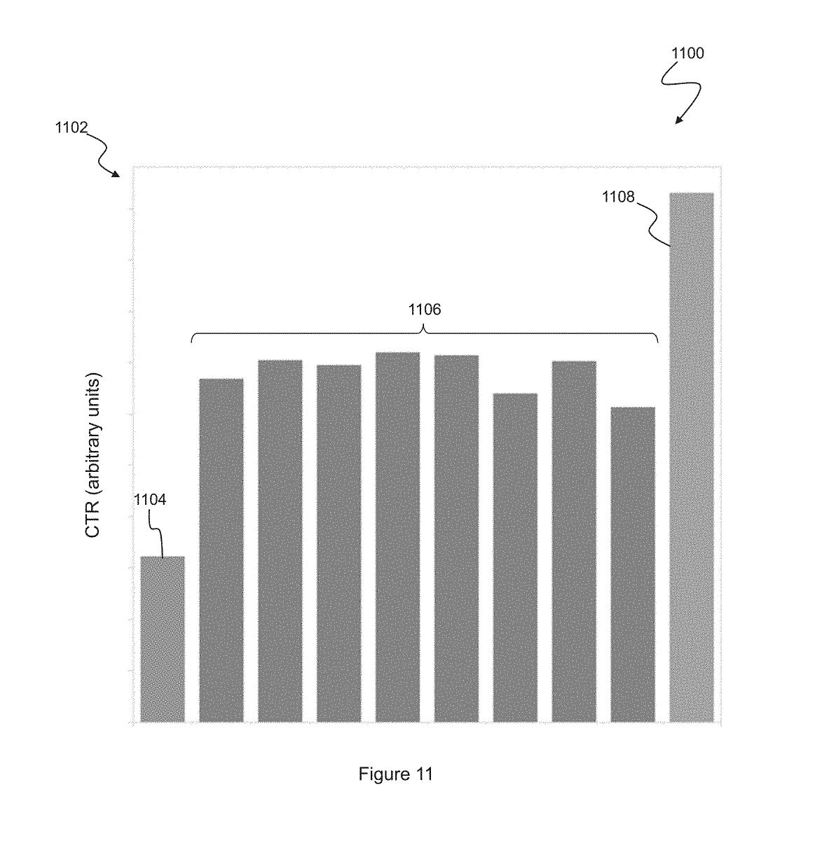

FIG. 6 is a block diagram 600 illustrating schematically a number of code components which comprise the real-time bidding module 316 described above with reference to FIG. 3. Each of these code components, which collectively comprise a technical contribution to the art specifically developed for the presently-described embodiment of the invention, is implemented within the program instructions 114 executing on the DSP server 102. Details of the algorithms implemented by the code components illustrated in FIG. 6 are described below with particular reference to the flowcharts shown in FIGS. 7 to 10, while the advantageous technical effects achieved by an exemplary embodiment are illustrated in the chart of FIG. 11.

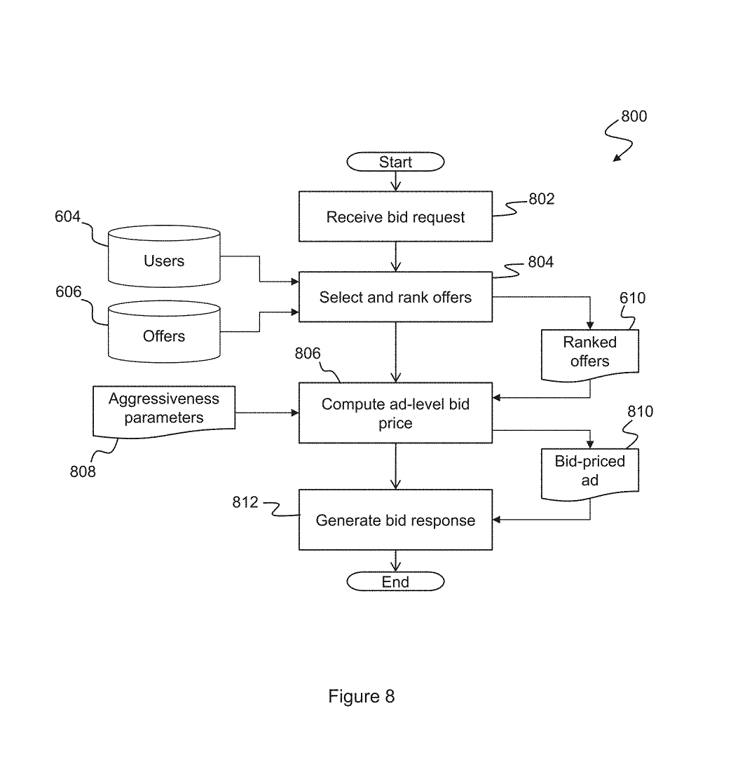

Input to the real-time bidding module 316 includes bid requests 210 received from the ad exchange server 122. An offer-level selection and ranking module or component 602 employs user information from an active users database 604, offer information from an active offers database 606 and, optionally, estimated offer-level CTR generated by a machine learning CTR estimator component 608, in order to generate a ranked set of offers 610 for possible inclusion in an ad to be generated in response to a bid request 210. Operation of the offer-level selection and ranking component 602 is described in greater detail below with reference to FIG. 8.

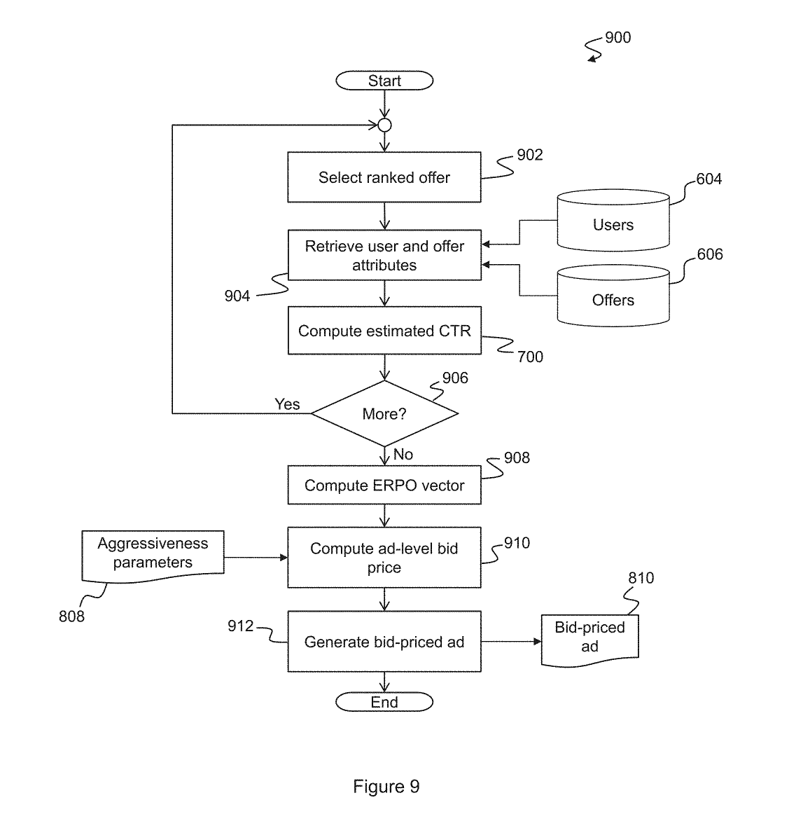

The ranked offers 610 are passed to an ad-level bid-price computation component 612, which employs the machine learning CTR estimator component 608 in order to generate a bid-priced ad. Operation of the ad-level bid-price computation component 612 is described in greater detail below, with particular reference to FIGS. 8 and 9. The bid-priced ad may be used to generate a bid response 214.

FIG. 7 is a flowchart 700 of a method of estimation of expected CTR by the CTR estimation component 608, using the machine learning model for online user interaction prediction described above with reference to FIGS. 3 to 5. At block 702, site, offer and user information is received, i.e., via transmission 210 from the ad exchange server 122, in conjunction with information retrieved from the active offers database 606 and any available information retrieved from the active users database 604. This information is used at block 704 to compute a corresponding enriched feature vector according to the definitions file 310.

At block 706, the real-time bidding module accesses the model representation 314 which, as has been described, comprises a set of coefficients stored in a highly efficient dictionary structure for rapid coefficient lookup. As described above, with reference to FIG. 4 in particular, the model may be updated from time-to-time by the ML server 152. The model representation 314 may be stored in a shared storage medium 308, and be asynchronously readable by the DSP server 102. In some embodiments, the DSP server may maintain a cached copy of the model representation 314 for rapid access, which is updated upon update of the stored file by the ML server 152.

The output of the model, generated at block 708, is an estimate of likelihood of user interaction with the offer, based on the enriched feature vector. In the exemplary embodiment, the output is a value representing a probability that the user will click on the offer. As will be appreciated, therefore, in this embodiment the model may equivalently be regarded as providing an estimated offer-level CTR, i.e., for a large ensemble of identical, independent users to which an offer is presented, the CTR is equal to the probability that each individual user will click on the offer. In the following discussion, the terms probability of interaction and CTR are used interchangeably.

FIG. 8 is a flowchart 800 of a method of generating a bid response, including a bid price, by the real-time bidding module 316. In particular, the flowchart 800 shows the blocks implemented by the offer-level selection and ranking component 602, and the high-level blocks implemented by the ad-level bid-price computation component 612. Details of a bid-price computation algorithm implemented by the ad-level bid-price computation component 612 are set out below, with reference to FIG. 9.

At block 802, a bid request 210 is received. At block 804, the offer-level selection and ranking component 602 executes one or more procedures to select and rank offers for possible inclusion within an ad generated in response to the bid request 210. From the perspective of the present invention, the significance of the offer-level selection and ranking component 602 is that it produces a ranked listing of offers selected from those available in the active offers database 606. Any suitable methods for doing so may be employed. Nonetheless, to assist in understanding of the invention, exemplary methods of offer-level selection and ranking are now outlined. As has been noted, the exemplary embodiment is implemented in the context of travel booking and related services, however the principles described may be applied to other contexts and subject matter.

As generally discussed above with reference to FIG. 1, for each ad slot (e.g., 148, 150) of given size and attributes, an ad may be dynamically built by the DSP 102, and may comprise up to n different offers. For example, as shown in FIG. 1 the ad slot 148 comprises up to three offers 148a, 148b, 148c, i.e., n=3. In other embodiments, however, the maximum number of offers that may be placed can be greater or less than three. In another common configuration n=4. The maximum number of offers may be larger where more space is available, such as where large banners are provided on a site. A number of offers, up to the maximum n, and the contents of each offer, are preferably selected in order to optimise the purchased space on the display 144, and increase a probability that the user interacts with (i.e., clicks on) at least one of the offers.

Accordingly, at block 804, the exemplary offer-level selection and ranking component 602 is configured by specific programming to select and rank, from active offers within the active offers database 606, a set of candidate offers O1, O2, . . . , On to fill the available ad slot in the bid request 210.

This block is mainly driven by domain-specific heuristics (i.e., for the travel domain, in the exemplary embodiment), designed based upon input from domain experts. The heuristics may include matching between attributes including characteristics derived from the request (e.g., website URL, a user travel destination derived from user search terms, a user origin location derived from an IP address of the user device 126, and so forth), and characteristics of offers present in the active offers database 606 (destination of the offer, price, type of product, and so forth). In selecting and ranking offers other business rules may also be applied, such as campaign activity begin and end dates, remaining budget, and so forth.

Matching heuristics may be implemented using suitable filters. In the exemplary embodiment, a first set of filters is applied using business rules in order to determine a first set of eligible offers. These filters eliminate past campaign material and/or offers that may be inactive or unavailable for some other business reason (e.g., offer expired, or budget exhausted).

A second set of travel-domain-specific filters is then employed for geographical matching between the destination of interest for the user, and the destinations associated with available offers. Hierarchical filtering may be employed, to support matching at greater and/or lesser degrees of specificity. For example, if a user's search terms indicate an interest in Mallorca as a destination, but there are no active offers specific to this destination, filters for ‘Spain’ may be applied, or even filters for ‘Europe’ if there are no active offers specific to ‘Spain’.

In one embodiment, offers matching characteristics of the request are then selected among the system-specified maximum n, to avoid over-computation costs both in CPU and time, and ordered by decreasing matching quality.

In an alternative embodiment, a larger number m>n offers may be selected. In this case, the ad-level bid-price computation component 612 may be required to evaluate all possible choices of n offers among m, e.g., according to the method described below with reference to FIG. 9. This embodiment has the advantage of extending the search domain for optimizing bid price, thus allowing for discovery of potentially more effective offer combinations.

A ranking of selected offers 610 is thereby generated, and made available to the ad-level bid-price computation component 612 which, at block 806, computes an ad-level bid price using aggressiveness-factor parameters 808, to produce a bid-priced ad 810, for use in generating 812 a bid response 214.

FIG. 9 is a flowchart 900 showing details of the ad-level bid price computation 806 using one or more aggressiveness-factor parameters 808. The ad-level bid price computation component 612 combines offer-related attributes with current bid request 210 user and context information, and executes the CTR estimation component 608 to compute a probability of click for each offer Oi generated by the offer-level selection and ranking component 602, according to the process 900.

At block 902, a ranked offer Oi (i=1, 2, . . . , n) is selected from the list generated by the offer-level selection and ranking component 602. At block 904, user and offer attributes are retrieved. In particular, user-related information is retrieved from the active users database, based on one-to-one exact matching (e.g., using user cookies), or on other matching of user characteristics where one-to-one matching is not possible (e.g., because the user has not been previously encountered). Further, offer-related information (e.g., destination of the offer, price, type of product, and so forth) is retrieved from the active offers database 606. The resulting set of features, comprising {offer Oi features; user features U; browsing context features C} are passed to the CTR estimation component 608 which executes the process 700 to compute the probability of a user interaction as Pi=P(click|{Oi; U; C}).

At decision block 906, a check is made to determine whether all offers have been processed, i.e., i=n. If not, control returns to block 902, and the next ranked offer is processed. Otherwise control passes to block 908, in which the ad-level bid price computation component 612 computes a vector quantity ERPO (Expected Revenue Per Offer), defined as:

ERPO=R∘P

where R=[R1, R2, . . . Rn] is a vector of revenues (i.e., CPCs agreed between the DSP operator and the respective advertisers) generated from a click of each offer Oi (i=1, 2, . . . , n), P=[P1, P2, . . . Pn] is a vector of the corresponding click-through probabilities determined as described above, and ‘ ’ denotes the Hadamard (i.e., element-wise) product of the vectors.

Intuitively, the ERPO corresponds to the average expected gain per offer to be shown in the ad slot, for each offer i. This vector comprises information enabling several possible choices for the bid price, e.g.:

a ‘conservative’ choice is to take the weighted average of click probabilities, weights being the respective revenue per offer, which can be computed as

$$\frac{1}{n} {\sum }_{i} {ERPO}_{i} ;$$

an ‘aggressive’ choice is to take the maximum of the expected revenue per offer, i.e.,

$${max}_{i} \vert {ERPO}_{i} \vert , \qquad$$

betting optimistically that the user will click on the most probable and revenue-generating offer for the DSP; or the range between those two extremes may be employed to implement intermediate levels of bidding aggressiveness.

A convenient way to define the full range of bidding aggression may be derived by first defining the p-norm of the ERPO:

$${‖ ERPO ‖}_{p} = {( {\sum }_{i} {\vert {ERPO}_{i} \vert}^{p} )}^{1 / p}$$

Notably, the above computation for aggressive bidding can be expressed as

$${‖ ERPO ‖}_{∞} = {lim}_{p \to ∞} {‖ ERPO ‖}_{p} = {max}_{i} \vert {ERPO}_{i} \vert$$

and, noting that ERPOᵢ≥0∀i⊂{1 . . . n}, the computation for conservative bidding can be expressed as

$$\frac{1}{n} {‖ ERPO ‖}_{1}$$

With a substitution

$$α = 1 - \frac{1}{p} ,$$

a bid-price function that is continuous on 0≤α≤1 can then be defined as:

$$BP ( α ) = ( \frac{1 - α}{n} + α ) \cdot {‖ ERPO ‖}_{1 / ( 1 - α )}$$

In the above equation, α is an aggressiveness-factor parameter 808 for which: α=0 corresponds with ‘conservative’ bidding; α=1 corresponds with ‘aggressive’ bidding; and 0<α<1 provides for smooth modulation of aggressiveness between the two extremes, as required.

The above computations are accordingly implemented at block 910 to generate a unique ad-level bid price based upon the offer-level CTR estimates for the ranked offers selected by the offer-level selection and ranking component 602, using a corresponding aggressiveness-factor parameter 808 that has been set according to advertiser, campaign and/or other requirements.

In some embodiments, a simple bid-price multiplier may be applied to the BP value computed above, in order to convert the value to an actual bid price in a currency supported by the ad exchange server 122. Further, in some embodiments, a price cap may also be applied to limit the actual bid price in case of obviously outlying values of click probability and/or bid prices, and to avoid excessive DSP expenditure on individual bids.

Finally, at block 912 the final bid-priced ad 810 is produced, which may be employed in the generation 812 of a bid response 214.

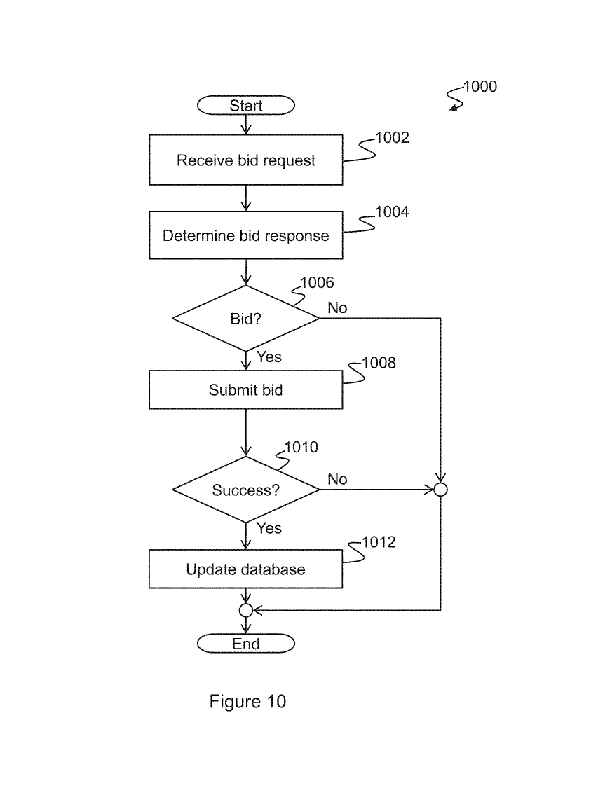

FIG. 10 is a flowchart 1000 of a method of overall operation of the real-time bidding module 316 embodying the embodiments of the invention, including post-bid processing to support online operation of the ML server 152. At block 1002, a bid request is received, while at block 1004 a bid response is determined. Accordingly, these two general blocks correspond with the processes described in detail above with reference to FIGS. 7 to 9.

At block 1006, a decision may be made on whether or not to transmit a bid response for the ad slot presented in the bid request 210. For example, if the computed bid price is unduly high (e.g., exceeds a cap price, or available budget constraint) or low (e.g., reflects a low probability of success and/or revenue generation), a decision may be made not to transmit the bid response. In the event that a decision is made to bid for the slot, control passes to block 1008 wherein the bid response is transmitted 214 back to the ad exchange server 122. In the event that the bid is successful, control is directed 1010 to block 1012, in which the database 166 is updated with details of the placement event.

In order to assess the performance of the real-time bidding module 316 embodying the invention, a number of experimental modules were run in parallel with a module implementing a bidding algorithm. FIG. 11 shows a chart 1100 illustrating performance of the experimental real-time bidding module embodying the invention. The chart 1100 shows click through rate (CTR) on the vertical axis 1102, with the corresponding performance of ten bidding modules shown as a series of bars. The bar 1104 represents the performance of a conventional bidding module, while the bars 1106 represent the performance of the experimental bidder embodying the invention, and employing a ‘conservative’ bidding strategy (α=0). These experimental bidders achieved CTRs averaging more than twice the performance of the conventional bidder 1104 without machine-learning-based CTR estimation. Finally, the bar 1108 represents the performance of the ‘aggressive’ bidder (α=1), which achieved a CTR in excess of three times that of the conventional bidder 1104. Accordingly, it is apparent that the aggressive bidder 1108 embodying the invention is more successful in winning ad slots with a high probability of user interaction compared with the conservative bidders 1106 and, even more so, with a conventional bidder 1104.

It should be appreciated that while particular embodiments and variations of the embodiments of the invention have been described herein, further modifications and alternatives will be apparent to persons skilled in the relevant arts. In particular, the examples are offered by way of illustrating the principles of the invention, and to provide a number of specific methods and arrangements for putting those principles into effect. In general, embodiments of the invention rely upon providing technical arrangements whereby automated real-time decision-making in relation to bidding at ad-level for slots in an online advertising system may be carried out based upon predictions of offer-level user interactions. A real-time bidding module embodying the invention is programmed to carry out technical actions, in response to a bid request message received from an ad exchange server, of performing domain-specific filtering of database records to select and rank offers, and computing a corresponding ad-level bid price based upon offer-level estimates of CTR, associated revenue values, and aggressiveness factor parameters. Notably, an algorithm is employed that enables continuous control of bidding aggressiveness between extremes of ‘conservative’ bidding (based upon a weighted average of estimated offer CTR) and ‘aggressive’ bidding (based upon expectation that a user interacts with an offer having the highest combination of estimated CTR and revenue generation).

In exemplary embodiments, the predictions of offer-level interactions are determined using a machine learning model trained using data derived from a database of placement and interaction events. Further technical actions implemented by such embodiments include matching of events to generate combined placement/interaction records that are tagged for use by supervised learning algorithms, calculation of enriched feature vectors for online learning, and training of a machine learning model based upon continuously updating event data to maintain a current and periodically-updating model representation having an efficient format usable by the real-time bidding module to make rapid decisions, e.g., in under 30 milliseconds.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

In certain alternative embodiments, the functions, acts, and/or operations specified in the flowcharts, sequence diagrams, and/or block diagrams may be re-ordered, processed serially, and/or processed concurrently consistent with embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A computing apparatus comprising:
one or more processors;
at least one memory device coupled with the one or more processors; and
a data communications interface operably associated with the one or more processors,
wherein the memory device contains a plurality of program instructions that, when executed by the one or more processors, cause the computing apparatus to:
receive, from an ad exchange server via the data communications interface, a message comprising a bid request which includes site information and user information relating to an available ad slot;
generate a ranked list of offers selected from an active offers database, wherein ranking of the offers is based at least in part on the site information and the user information;
for each offer in the ranked list, compute an offer-level estimate of probability of user interaction with the offer;
for at least one combination of offers included in the ranked list, compute an ad-level bid price, wherein the ad-level bid price is based on at least the computed offer-level estimates of probability of user interaction, corresponding offer-level interaction revenues, and an aggressiveness parameter that controls aggressiveness of bid pricing; and
transmit, to the ad exchange server via the data communications interface, a message comprising a bid response including a bid-priced ad, wherein the bid-priced ad comprises the combination of offers and the ad-level bid price.

2. The apparatus of claim 1 wherein the aggressiveness parameter comprises a conservative′ limiting value, for which the program instructions cause the computing apparatus to:
compute the ad-level bid price based upon a weighted average of the computed offer-level estimates of probability of user interaction,
and weightings of the weighted average comprise the corresponding offer-level interaction revenues.

3. The apparatus of claim 1 wherein the aggressiveness parameter comprises an ‘aggressive’ limiting value, for which the program instructions cause the computing apparatus to:
compute the ad-level bid price based upon a highest value of a product of computed offer-level estimate of probability of user interaction and corresponding offer-level interaction revenue.

4. The apparatus of claim 1 wherein the aggressiveness parameter comprises a continuous numerical value a, and the program instructions cause the computing apparatus to compute the ad-level bid price BP based upon a formula:
$$BP ( α ) = ( \frac{1 - α}{n} + α ) \cdot {‖ ERPO ‖}_{1 / ( 1 - α )}$$
wherein:
ERPO=R∘P
R=[R₁, R₂, . . . , Rₙ] is a vector of offer-level interaction revenues generated from user interaction with each offer Oᵢ (i=1, 2, . . . , n) in the ranked list of offers
P=[P₁, P₂, . . . , Pₙ] is a vector of the computed offer-level estimates of probability of user interaction
n is a number of offers to be included in the available ad slot, and
‘∘’ denotes an element-wise product of vectors.

5. The apparatus of claim 1 wherein the offer-level interaction revenues comprise cost-per-click (CPC) values agreed between an operator of the demand side platform and respective advertisers of the offers selected from the active offers database.

6. A method comprising:
receiving, from an ad exchange server via a data communications network, a message comprising a bid request which includes site information and user information relating to an available ad slot;
generating a ranked list of offers selected from an active offers database, wherein ranking of the offers is based at least in part on the site information and the user information;
for each offer in the ranked list, computing an offer-level estimate of probability of user interaction with the offer;
for at least one combination of offers included in the ranked list, computing an ad-level bid price, wherein the ad-level bid price is based on at least the computed offer-level estimates of probability of user interaction, corresponding offer-level interaction revenues, and an aggressiveness parameter that controls aggressiveness of bid pricing; and
transmitting, to the ad exchange server via the data communications network, a message comprising a bid response including a bid-priced ad, wherein the bid-priced ad comprises the combination of offers and the ad-level bid price.

7. The method of claim 6 wherein the aggressiveness parameter is variable between two limits.

8. The method of claim 7 wherein a first one of the two limits is a ‘conservative’ bidding limit based upon a weighted average of the computed offer-level estimates of probability of user interaction.

9. The method of claim 8 wherein weightings of the weighted average comprise the corresponding offer-level interaction revenues.

10. The method of claim 7 wherein a second one of the two limits is an ‘aggressive’ bidding limit based upon a highest value of a combination of computed offer-level estimate of probability of user interaction and corresponding offer-level interaction revenue.

11. The method of claim 10 wherein the combination comprises a product.

12. The method of claim 7 wherein each one of the two limits is finite.

13. The method of claim 7 wherein the aggressiveness parameter is continuously variable between the two limits.

14. The method of claim 6 wherein computing each offer-level estimate of probability of user interaction with the offer comprises:
executing a trained machine learning model.

15. The method of claim 14 wherein the machine learning model is trained using a data set comprising aggregated content placement events matched with aggregated user interaction events.

16. The method of claim 15 wherein the machine learning model is continuously or periodically trained online.

17. A computer program product comprising:
a computer readable storage medium; and
program code on the computer readable storage medium, the program code including instructions that, when executed by one or more processors, cause the one or more processors to:
receive, from an ad exchange server via the data communications interface, a message comprising a bid request which includes site information and user information relating to an available ad slot;
generate a ranked list of offers selected from an active offers database, wherein ranking of the offers is based at least in part on the site information and the user information;
for each offer in the ranked list, compute an offer-level estimate of probability of user interaction with the offer;
for at least one combination of offers included in the ranked list, compute an ad-level bid price, wherein the ad-level bid price is based on at least the computed offer-level estimates of probability of user interaction, corresponding offer-level interaction revenues, and an aggressiveness parameter that controls aggressiveness of bid pricing; and
transmit, to the ad exchange server via the data communications interface, a message comprising a bid response including a bid-priced ad, wherein the bid-priced ad comprises the combination of offers and the ad-level bid price.
